(19) United States
(12) Patent Application Publication
(10) Pub. No.: US 2007/0136344 A1
(43) Pub. Date: Jun. 14, 2007

(54) File compression system and method

(75) Inventor: Po-Jui Chen, Taipei (TW)

Correspondence Address: FULBRIGHT AND JAWORSKI LLP, 555 S. FLOWER STREET, 41ST FLOOR, LOS ANGELES, CA, 90071, US

(73) Assignee: INVENTEC CORPORATION

(21) Appl. No.: 11/389,327

(22) Filed: Mar. 24, 2006

(30) Foreign Application Priority Data
Dec. 13, 2005 (TW) 94143992

(51) Int. Cl. G06F 7/00

(52) U.S. Cl. 707/101

(57) ABSTRACT

A file compression system and method for compressing an intended file to reduce the time taken to open the file, wherein it entails storing at least one piece of data about the authority to read which includes a reading parameter and a compression coefficient corresponding to the reading parameter, loading and storing the intended file, inputting a reading parameter, retrieving from the stored data about the authority to read a conforming reading parameter and a compression coefficient corresponding to the reading parameter according to the inputted reading parameter, compressing the loaded file, stored and intended, according to the reading parameter read and a compression coefficient corresponding to the reading parameter, and finally storing the compressed loaded file.

### FIELD OF THE INVENTION

The present invention relates to a file compression system and the method thereof, and more particularly, to a file compression system and method for compressing circuit layout files according to an electronic product manufacturer's specific department attributes, to enable whoever need to read the files to swiftly open the intended files.

### DESCRIPTION OF THE PRIOR ART

The most popular and convenient drawing tool nowadays is CAD, because CAD assists electronic circuit layout engineers, electronic circuit designers and administrative personnel in performing any requisite drawing or design tasks.

With the advancement and development of the electronic technology, electronic products are becoming more versatile, and their accompanying circuit layouts are relatively complex as well. CAD-created circuit layout files require increasingly great storage capacity, which results in increasing time for opening any circuit layout files of this type, and, in particular, opening the files with a low-performance computer can be even much slower. Also, once opened, a circuit layout file of complicated circuit layouts will occupy much more memory space, to allow the file to be read by computer.

In addition, it is an electronic product manufacturer's specific department attributes that determine the need for reading circuit layout files and the way to process the files. Generally speaking, administrative personnel only need to read the component symbol file included in a circuit layout file, whereas electronic circuit layout engineers need to read both the component symbol file and the net file included in a circuit layout file. Despite the discrepancy in both the reading need and the processing manner, it is necessary to read, in practice, whatever a circuit layout file contains. Hence, it is time-consuming to process a circuit layout file of complicated circuit layouts in the aforesaid way, as far as file opening is concerned.

Processing circuit layout files, according to an electronic product manufacturer's specific department attributes, with a view to meeting the reading need and reducing the file opening time is an important issue to be urgently addressed by the electronic product manufacturers indeed.

### SUMMARY OF THE INVENTION

Accordingly, to solve the drawbacks of the aforesaid conventional technology, it is a primary objective of the present invention to provide a file compression system and method for reading and processing files automatically according to an electronic product manufacturer's specific department attributes, to reduce the time taken to open the files.

In order to achieve the above and other objectives, a file compression system and method are provided according to the present invention. The file compression system is intended to compress any intended files and reduce the time taken to open the files. The file compression system comprises a file loading module for loading an intended file, a loaded file storage area for storing a file loaded by the file loading module, a parameter input module for inputting a reading parameter required to read a file stored on the loaded file storage area, an authority to read storage area for storing at least one piece of data about the authority to read which includes the reading parameter and a compression coefficient corresponding to the reading parameter, a comparison module for retrieving from the authority to read storage area a conforming reading parameter and a compression coefficient corresponding to the reading parameter according to a reading parameter inputted by the parameter input module, a compression module for compressing a loaded file stored on the loaded file storage area according to a reading parameter read by the comparison module and a compression coefficient corresponding to the reading parameter, and a compressed file storage area for storing a loaded file compressed by the compression module for the sake of subsequent file opening.

The file compression method is intended to compress any intended files and reduce the time taken to open the files. The file compression method consists of the following steps: storing at least one piece of data about the authority to read which includes a reading parameter and a compression coefficient corresponding to the reading parameter, loading an intended file and storing it, inputting the reading parameter, retrieving from the stored piece of data about the authority to read a conforming reading parameter and a compression coefficient corresponding to the reading parameter according to a reading parameter inputted, compressing a loaded file, stored and intended, according to the reading parameter read and its corresponding compression coefficient, and storing the loaded file compressed for the sake of subsequent file opening.

As opposed to the prior art, the file compression system and method of the present invention not only efficiently solve the known drawbacks, namely that the conventional method for opening files is time-consuming, and that a file opened usually occupies considerable memory space, but the file compression system and method also provides a security mechanism for reading files for a confidential purpose.

### BRIEF DESCRIPTION OF THE DRAWINGS

FIG. 1 is a block diagram showing the basic structure of a file compression system according to the present invention;

FIG. 2 is a flow diagram showing the steps in a file compression method according to the present invention;

FIG. 3(A) is an exemplary schematic diagram showing the displayed contents of a source circuit layout file opened; and

FIG. 3(B) is an exemplary schematic diagram showing the displayed contents of a source circuit layout file compressed and opened by the file compression system and method according to the present invention.

### DETAILED DESCRIPTION OF THE PREFERRED EMBODIMENT

The following descriptions of a specific embodiment are to illustrate the present invention. Others skilled in the art can easily understand other advantages and features of the present invention from contents disclosed in this specification. The present invention can be implemented or applied through other different embodiments. Every details of this specification can be modified or changed based on different viewpoints and applications yet still within the scope of the present invention.

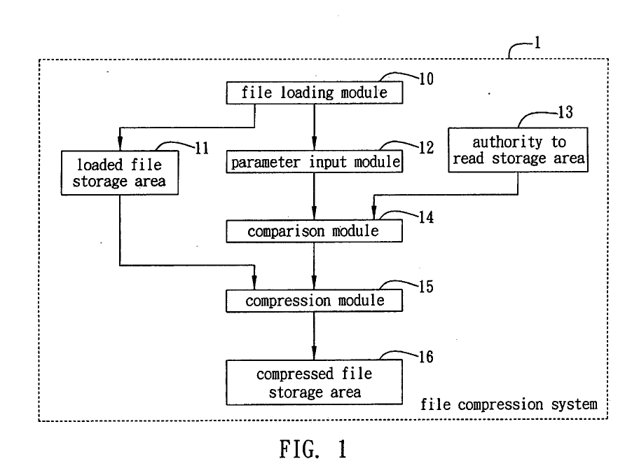

FIG. 1 is a block diagram showing the basic structure of a file compression system according to the present invention. As shown in the figure, a file compression system 1 of the present embodiment is applicable to the file opening stage; for instance, opening a CAD-created circuit layout file, and compressing the intended circuit layout file beforehand, to reduce the time taken to open the file. Furthermore, the file compression system 1 of the present embodiment is executed by means of a computer (not shown) equipped with an output module (for example, a monitor) and an input module (for example, a keyboard or a mouse). As shown in the figure, the file compression system 1 comprises a file loading module 10, a loaded file storage area 11, a parameter input module 12, an authority to read storage area 13, a comparison module 14, a compression module 15, and a compressed file storage area 16.

The file loading module 10 loads an intended file. The intended file is a file already stored on a storage area, such as the hard disk of a computer, a USB flash drive externally connected to the computer, or a web hard drive to which the computer is hooked up (none is shown), using a loading path inputted by the user. Furthermore, the intended file is, for example, a CAD-created circuit layout file.

The loaded file storage area 11 stores a file loaded by the file loading module 10. The loaded file storage area 11 is a storage area, such as the hard disk of a computer, a USB flash drive externally connected to the computer, or a web hard drive to which the computer is hooked up.

The parameter input module 12 enables the user to input, via an input module of the computer (for example, a keyboard or a mouse), a reading parameter for reading a file stored on the loaded file storage area 11; the reading parameter of the present embodiment refers to a department code for an electronic product manufacturer's specific department, for example, the department code for a design department, or that for an electronic circuit layout department.

The authority to read storage area 13 stores at least one piece of data about the authority to read which includes a reading parameter and a compression coefficient corresponding to the reading parameter; in the present embodiment, the reading parameter refers to a department code for an electronic product manufacturer's specific department, whereas the compression coefficient corresponding to the reading parameter refers to extracting from a loaded file its necessary contents according to an involved department's attribute; for example, if the reading parameter of the data about the authority to read refers to a design department, then its corresponding compression coefficient refers to the component symbol file; another example is that, if the reading parameter of the data about the authority to read refers to an electronic circuit layout department, then its corresponding compression coefficient refers to the component symbol file and the net file.

The comparison module 14 retrieves from the authority to read storage area 13 a conforming reading parameter and a compression coefficient corresponding to the reading parameter, according to a reading parameter inputted by the parameter input module 12. If the comparison module 14 fails to retrieve any conforming reading parameter from the authority to read storage area 13 according to a reading parameter inputted by the parameter input module 12, then the input module of the computer outputs a prompt message about the failure to read a loaded file stored on the loaded file storage area 11.

The compression module 15 compresses a loaded file stored on the loaded file storage area 11 according to a reading parameter read by the comparison module 14 and a compression coefficient corresponding to the reading parameter; in the present embodiment, if the loaded file and the reading parameter belong to a circuit layout file and a design department's department code respectively, only the component symbol file included in the circuit layout file needs to be read; however, if the reading parameter is an electronic circuit layout department's department code, then it is necessary to read both the component symbol file and the net file included in the circuit layout file. In other words, the compression task performed by the compression module 15 entails retrieving the necessary, rather than the whole, contents of the file according to a department attribute.

The compressed file storage area 16 stores a loaded file compressed by the compression module 15 to allow the user to promptly access the intended contents of the file, so as to overcome a known drawback, that is, with the conventional method, users end up opening all the files comprised in the circuit layout file, which is a time-consuming process.

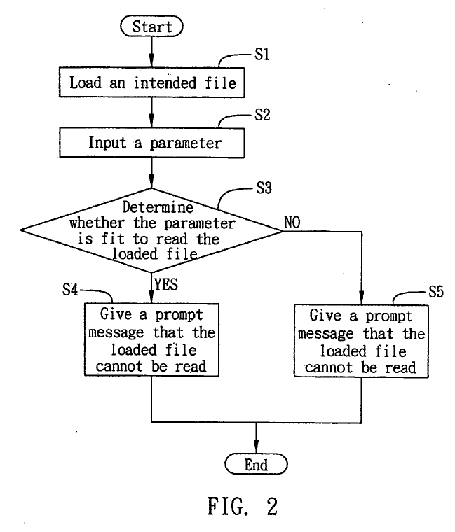

FIG. 2 is a flow diagram showing the steps in the file compression method according to the present invention. As shown in the figure, the file compression method of the present embodiment is applicable to the file opening stage; for instance, opening a CAD-created circuit layout file, and compressing the intended circuit layout file beforehand, to reduce the time taken to open the file. Furthermore, the file compression method of the present embodiment is executed by means of a computer (not shown) equipped with an output module (for example, a monitor) and an input module (for example, a keyboard or a mouse), referring to the file compression system 1 depicted in FIG. 1 as well. Prior to the execution of the file compression method in accordance with the present invention, it is necessary to create, in advance, the authority to read storage area 13 for storing at least one piece of data about the authority to read, wherein the data about the authority to read comprises a reading parameter and a compression coefficient corresponding to the reading parameter; afterward, Step S1 shown in the figure is executed, that is, loading an intended file, wherein the intended file is a file already stored on a storage area, such as the hard disk of a computer, a USB flash drive externally connected to the computer, or a web hard drive to which the computer is hooked up (none is shown), using a loading path inputted by the user; then, proceed to Step S2.

In Step S2, the parameter input module 12 enables the user to input, via an input module of the computer (for example, a keyboard or a mouse), a reading parameter for reading a loaded file stored on the loaded file storage area 11; the reading parameter of the present embodiment refers to a department code for an electronic product manufacturer's specific department; then, proceed to Step S3.

In Step S3, the comparison module 14 determines whether a conforming reading parameter can be retrieved from the authority to read storage area 13 according to a reading parameter inputted by the parameter input module 12; in the event of an answer in the affirmative, proceed to Step S4, otherwise proceed to Step S5.

In Step S4, upon the retrieval of a conforming reading parameter by the comparison module 14 from the authority to read storage area 13 according to a reading parameter inputted by the parameter input module 12, the compression module 15 compresses a loaded file stored on the loaded file storage area 11 according to a reading parameter read by the comparison module 14 and a compression coefficient corresponding to the reading parameter, and then saves the compressed file to the compressed file storage area 16, to enable the computer to swiftly open the file the user needs, according to the compressed file stored on the compressed file storage area 16, and thereby efficiently solve the known drawbacks, namely, the conventional method for opening files is time-consuming, and a file opened usually occupies considerable memory space.

In Step S5, the comparison module 14 fails to retrieve any conforming reading parameter from the authority to read storage area 13 according to a reading parameter inputted by the parameter input module 12, then the input module of the computer outputs a prompt message about the failure to read a loaded file stored on the loaded file storage area 11, and ends the operation flow of the file compression method in accordance with the present invention.

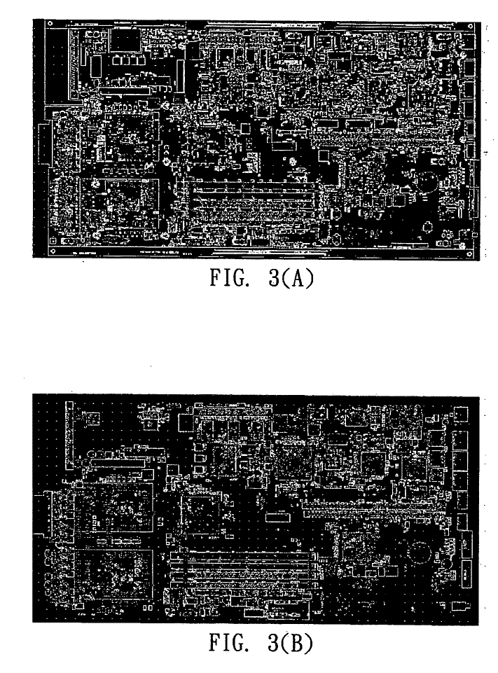

FIG. 3(A) is an exemplary schematic diagram showing the displayed contents of a source circuit layout file opened, whereas FIG. 3(B) is an exemplary schematic diagram showing the displayed contents of a source circuit layout file compressed and opened by the file compression system and method according to the present invention. As shown in FIGS. 3(A) and 3(B), based on a parameter input by the user (for example, a department code in the present embodiment), compression of a circuit layout file of complicated circuit layouts can be performed to retrieve the file contents the user needs, in other words, not all the related contents of the file are necessarily accessed, thus file opening can be efficiently speeded up, and less memory space is occupied by the opened files.

In short, not only do the file compression system and method of the present invention prove effective to overcome the known drawbacks, namely, that the conventional method for opening files is time-consuming, and that a file opened usually occupies considerable memory space, but the authority to read storage area, coupled with the operation of the comparison module, provides a security mechanism for achieving file confidentiality during file reading. Hence, the file compression system and method of the present invent excel any known file opening mechanism in opening circuit layout files of complicated circuit layouts and processing files safely.

The embodiment described above is only to illustrate characteristics and functions of the present invention; it should not be construed as to limit the scope of the present invention in terms of substantial technology. The substantial technology of the present invention is broadly defined by the appended claims. A technological entity or method devised by any other person will always be regarded as falling within the scope of the present claims, provided that it is the like of any one defined by the appended claims or is an equivalent change.

What is claimed is:

1. A file compression system for compressing a desired file prior to opening the desired file, the file compression system comprising:
a file loading module for loading the desired file;
a loaded file storage area for storing the file loaded by said file loading module;
a parameter input module for inputting a reading parameter for reading said file stored on said loaded file storage area;
an authority to read storage area for storing at least one piece of data about authority to read, wherein said data about authority to read comprises a reading parameter and a compression coefficient corresponding to said reading parameter;
a comparison module for retrieving from said authority to read storage area, according to a reading parameter inputted by said parameter input module a conforming reading parameter and a compression coefficient corresponding to said reading parameter;
a compression module for compressing said loaded file stored on said loaded file storage area according to said reading parameter read by said comparison module and said compression coefficient corresponding to said reading parameter; and
a compressed file storage area for storing said loaded file compressed by said compression module for the sake of file opening.

2. The file compression system as claimed in claim 1, wherein said file compression system is integrated into a computer equipped with an output module so that said output module outputs a prompt message about failure to read said loaded file stored on said loaded file storage area whenever said comparison module fails to retrieve a conforming reading parameter from said authority to read storage area according to said reading parameter inputted by said parameter input module.

3. The file compression system as claimed in claim 1, wherein said reading parameter of said data about authority to read refers to a department code for an electronic product manufacturer's specific department.

4. The file compression system as claimed in claim 1, wherein said desired file refers to a CAD-created circuit layout file.

5. The file compression system as claimed in claim 4, wherein said reading parameter of said data about authority to read refers to a department code for a circuit design manufacturer's specific department, and compression of said loaded file stored on said loaded file storage area by said compression module refers to retrieval of necessary circuit layout contents from circuit layouts of said circuit layout file according to the department code and an attribute of said department.

6. A file compression method for compressing a desired file prior to opening the desired file, said file compression method comprising the steps of:
storing at least one piece of data about authority to read, wherein said data about authority to read includes a reading parameter and a compression coefficient corresponding to reading parameter;
loading and storing the desired file;
inputting a reading parameter;
retrieving from said stored data about authority to read a conforming reading parameter and a compression coefficient corresponding to said reading parameter, according to said inputted reading parameter;
compressing said loaded and stored desired file according to said reading parameter read and said compression coefficient corresponding to said reading parameter; and
storing said compressed loaded file for the sake of file opening.

7. The file compression method as claimed in claim 6, wherein said file compression method is integrated into a computer equipped with an output module so that said output module outputs a prompt message about failure to read said loaded and stored file whenever it fails to retrieve a conforming reading parameter from said stored data about authority to read according to said inputted reading parameter.

8. The file compression method as claimed in claim 6, wherein said reading parameter of said data about authority to read refers to a department code for an electronic product manufacturer's specific department.

9. The file compression method as claimed in claim 6, wherein said desired file refers to a CAD-created circuit layout file.

10. The file compression method as claimed in claim 9, wherein said reading parameter of said data about authority to read refers to a department code for a circuit design manufacturer's specific department, and compression of said loaded and stored file refers to retrieval of necessary circuit layout contents from circuit layouts of said circuit layout file according to the department code and an attribute of said department.
